(19) United States
(12) Patent Application Publication
(10) Pub. No.: US 2007/0166575 A1
(43) Pub. Date: Jul. 19, 2007

(54) FLUID FUEL CARTRIDGE WITH AN INTEGRATED CONTENT MODULE

(76) Inventor: D. David McLeod, Langley (CA)

Correspondence Address: MCANDREWS HELD & MALLOY, LTD, 500 WEST MADISON STREET, SUITE 3400, CHICAGO, IL, 60661, US

(21) Appl. No.: 11/617,941

(22) Filed: Dec. 29, 2006

Related U.S. Application Data
(60) Provisional application No. 60/754,917, filed on Dec. 29, 2005.

(51) Int. Cl. H01M 8/00

(52) U.S. Cl. 429/12

(57) ABSTRACT

A removable fluid fuel cartridge has an integrated content module. The cartridge/content module includes a cartridge housing, a fuel reservoir and a content module incorporated in the cartridge. The cartridge housing fluidly connectable to the fuel inlet of at least one electrochemical fuel cell providing electric power to a mobile electrical device. The fuel reservoir is disposed within the cartridge housing for containing a quantity of fuel capable of being directed in a fluid stream to at least one fuel cell for accommodating an electrochemical reaction capable of supplying electrical power to the device. The content module is incorporated in the cartridge, and is independently capable of producing a perceivable stimulus.

### CROSS-REFERENCE TO RELATED APPLICATION(S)

This application relates to and claims priority benefits from U.S. Provisional Patent Application Ser. No. 60/754,917, filed Dec. 29, 2005, entitled “Fluid Fuel Cartridge With An Integrated Content Module”. The '917 provisional application is hereby incorporated by reference herein in its entirety.

### FIELD OF THE INVENTION

The present invention relates to removable fuel cartridges for fuel cell powered electrical devices. In particular, the present invention relates to removable cartridges for containing and directing fluid fuel to a fuel cell powered wireless communication device and the like, and in which a content module integrated with the cartridge is capable of providing functional content to the user.

### BACKGROUND OF INVENTION

Wireless electronic communication devices such as cellular telephones can frequently incorporate on or more other functional devices, such as email devices, video game systems, photographic and video cameras, television receivers, global positioning systems, medical monitoring devices and music players. The ability of such a device to perform other functions relieves users of having to carry multiple devices to provide entertainment and/or information display functions on their wireless communication devices. The presence of multiple features and functions in a single communication device is attractive to consumers who have a broad range of devices from which to choose.

One shortcoming of conventional multi-function wireless communication devices is the non-modifiable nature of the built-in functions. In this regard, a conventional cellular telephone that does not already contain one or more of the functionalities normally found in separate devices cannot later, at the user's option, become multi-functional. Similarly, a conventional wireless communication device having a built-in music player cannot presently be adapted so as to incorporate a digital camera, a television receiver or similar functionality. Owners of such conventional devices who wish to have these additional features resident on their devices must instead purchase an entirely new device having the desired complement of functions, and then discard their obsolete devices.

Another disadvantage of conventional wireless communication devices is their need to be recharged. Owners of such devices must have access to chargers for connection to an AC power source when the batteries become depleted. This is especially inconvenient when traveling, in which case the device owner must carry charging equipment and wait for opportunities to connect to an AC outlet. The presence of multiple functionalities on a single device imposes further power demands on the device, thereby decreasing the operating time between rechargings and increasing the frequency of required rechargings. The implementation of fluid fed electrochemical fuel cells as electric power sources for wireless communication devices obviates the need for recharging provided, of course, that sources of fuel are conveniently available.

Fuel contained within interchangeable cartridges are envisioned as a convenient means for providing fuel to electrochemical fuel cells incorporated into mobile devices like cellphones. The interchangeability of such cartridges provides an opportunity to impart content to the device in which the cartridge is installed. In addition to fuel, each replaceable fuel cartridge can contain and direct content to the device. In effect, such fuel cartridges with integrated content modules provide functional expandability to the devices in which they are installed, by performing the additional functions themselves. Many valuable devices and services are time-sensitive and disposable after short periods of time, hence it would be advantageous to have a method of replacing multiple elements at once, for example when replacing a fuel cartridge where the expired elements have a similar expiry range.

### SUMMARY OF THE INVENTION

Several shortcomings of the prior uses of multi-function electronic wireless communication devices are overcome by the present fluid fuel cartridge with an integrated content module. Additionally, one or more of the shortcomings of fluid feed electrochemical fuel cell power supplies for such wireless devices are also overcome by the present fuel cartridge for a wireless communication device with integrated content module. A fluid fuel cell powered wireless device that is fluidly connectable to a replaceable cartridge containing both a quantity of fluid fuel capable of undergoing an electrochemical reaction within said fuel cell, and a content module capable of receiving, storing and generating content allows a single wireless device to support additional functions. The replaceable nature of the cartridge eliminates the possibility that a device will become obsolete when new technology makes new functions possible, or when the user desires additional functions for the wireless device. Additionally, including independently playable content in the power supply device provides luring incentives for users to abandon traditional rechargeable batteries in spite of having to periodically purchase replacement power supply sources.

In one embodiment of the present cartridge/content module, a wireless electronic device includes a direct liquid feed fuel cell. To power the fuel cell, the wireless device is fluidly connectable to a replaceable cartridge that houses a fuel reservoir containing a quantity of fuel that is capable of undergoing an electrochemical reaction within the fuel cell. A fuel cartridge can contain media in the form of a digital movie or a video game that is independently playable.

The function of the cartridge is not limited to data transmission and storage. In another embodiment, the fuel cartridge can contain functional tools that can be useful for safety, testing and monitoring and food storage. In yet another embodiment of the present fluid fuel cartridge with an integrated content module, the cartridge can contain hardware that interacts with external sources. Television and radio antennae, garage door openers, laser pointers, or an alcoholic breath-analyzing tool to assess the blood-alcohol level of the user who breathes into it are other examples of this embodiment. A user that wishes to have an array of these functions available for its wireless device need not, therefore, purchase multiple, and more expensive, wireless devices. The user can instead purchase individual functional fuel cartridges with the desired content when they become available.

### BRIEF DESCRIPTION OF THE DRAWING(S)

FIG. 1 is a perspective view of a general function content module integrated into a liquid fuel cartridge.

FIGS. 2a and 2b are top and cross-sectional views, respectively, of a passive deodorizing module coupled to a fuel cartridge, with manual adjustment.

FIGS. 3a and 3b illustrate perspective and schematic views, respectively, of an active fragrance dispenser module coupled to a fuel cartridge.

FIG. 4 is a cross-sectional view of an actuable irritant spray dispenser, integrated in an interior cavity of a fuel cartridge.

FIG. 5 is a perspective view of a chemically activated heat-generating module attached to a fuel cartridge.

FIG. 6 is a perspective view of two light sources, LED illumination module and laser pointing device, coupled to a fuel cartridge.

FIG. 7 is a perspective view of visual chemical indicator module and radiation sensor module, coupled to a fuel cartridge.

FIG. 8a is a top view and FIG. 8b is a schematic depiction of an electronic module for storage, playback, recording and manipulation of audio, video and data.

FIG. 9a is a top view and FIG. 9b is a schematic depiction of a wireless broadcast receiver player for decoding and playing audio and video, coupled to a fuel cartridge.

### DETAILED DESCRIPTION OF PREFERRED EMBODIMENT(S)

At least some of the problems of delivering additional functions and services in proximity to a mobile device are overcome by using available space of a fuel cartridge for providing fuel to the mobile device power source. Broadly, mobile devices can operate from gas fuel, liquid fuel or solid fuel, as best suited for the energy density and economics of an application. For the purposes of illustration liquid fuel cartridges will be described in the embodiments of the present fluid fuel cartridge with integrated content module.

Content is defined broadly as content perceptible to a human user. Specifically, a stimulus can be one or more of visual, audible, smell or scent, tactile, gustatory, medicinal. In general a content module is said to be passive if it requires no additional power source, and active if it requires power within the content module to create the stimulus. The content module can be responsive to external conditions imperceptible to users, but will create an associated perceptible stimulus.

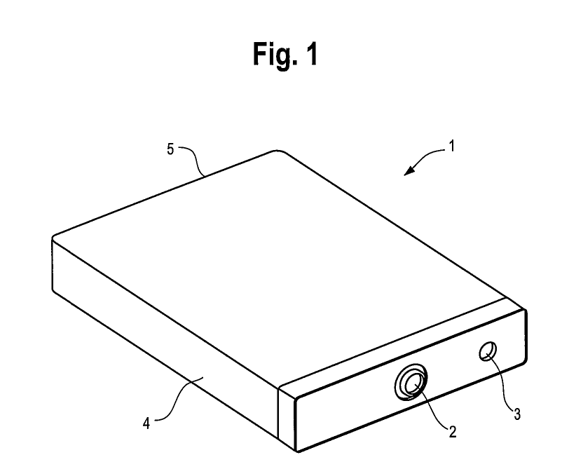

FIG. 1 illustrates a general case of a liquid fuel cartridge 4 coupled to an integrated content module 6 to create a cartridge with content module 1. This figure shows a perspective view of a general function content module integrated into a liquid fuel cartridge. A fuel cartridge can have a rectangular shape as shown or other shape suited to the power application. In particular for liquid fuel, there is a fuel port 2 and optionally a relief valve 3, shown in this example on fuel port interface cover 7, but alternatively located on another surface of the cartridge housing.

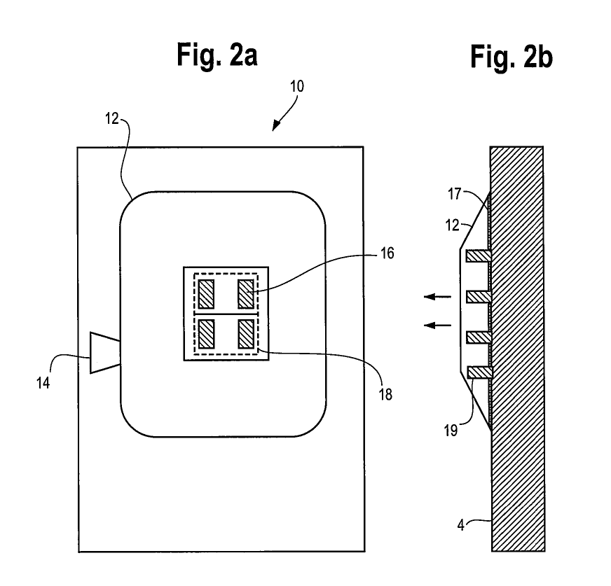

It is desirable to have deodorizers near a fuel cartridge to mask the scent of fuel. Similarly with mobile devices carried in vehicles, deodorizing the vehicle interior is also desirable. A solution for a replaceable deodorizing module is shown in FIG. 2, a fuel cartridge with passive odor module 10. Deodorizing module 12 includes in a central region, having vapor releasing material 16. Vapor-releasing material can be a gel, liquid, permeable fiber or polymer as commonly used in disposable consumer deodorizer products. The vapor releasing material can optionally be modularly replaceable by removing the top cover and removing them in holder 18. In the side view, vents 19 can be provided to allow airflow through the material 16 and out the front holes. The deodorizing module 12 is shown adhered to the fuel cartridge by adhesive layer 17, and alternative securing designs could be used including clasps, Velcro, fasteners and the like. In an alternate embodiment, manual actuator 14 can be adjusted to partially open or close the openings 16 to provide stronger or weaker odor control.

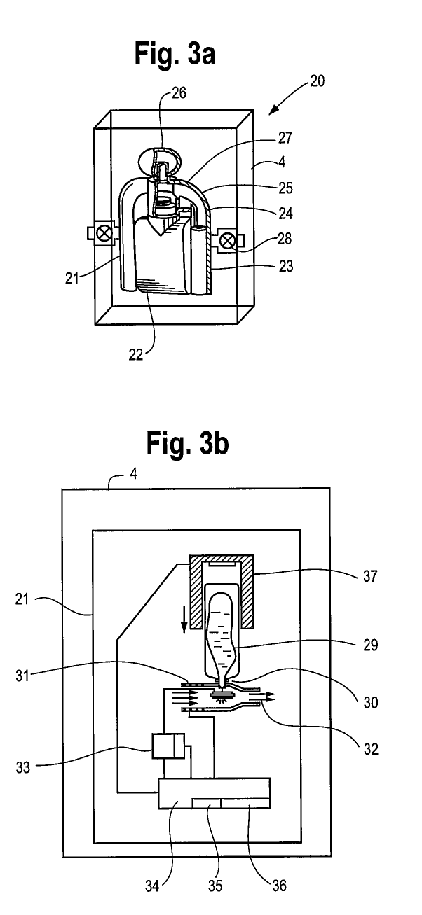

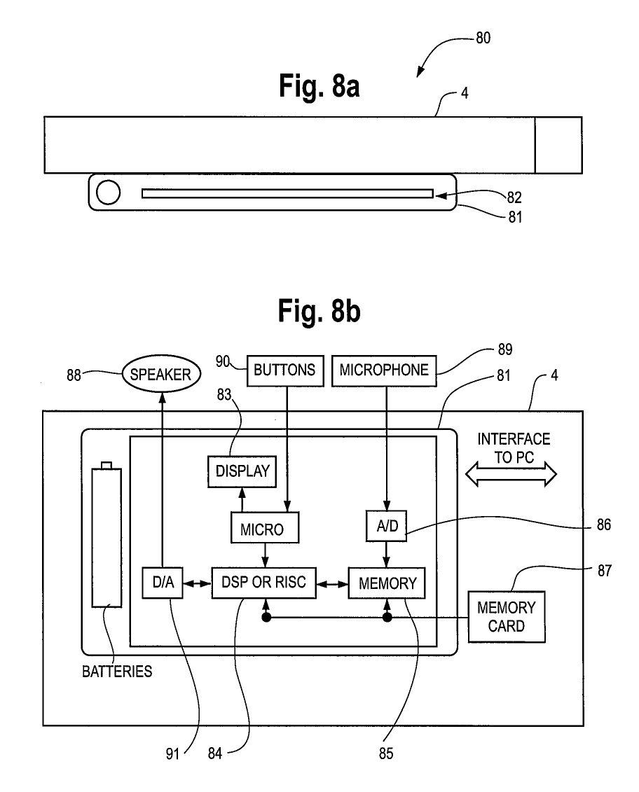

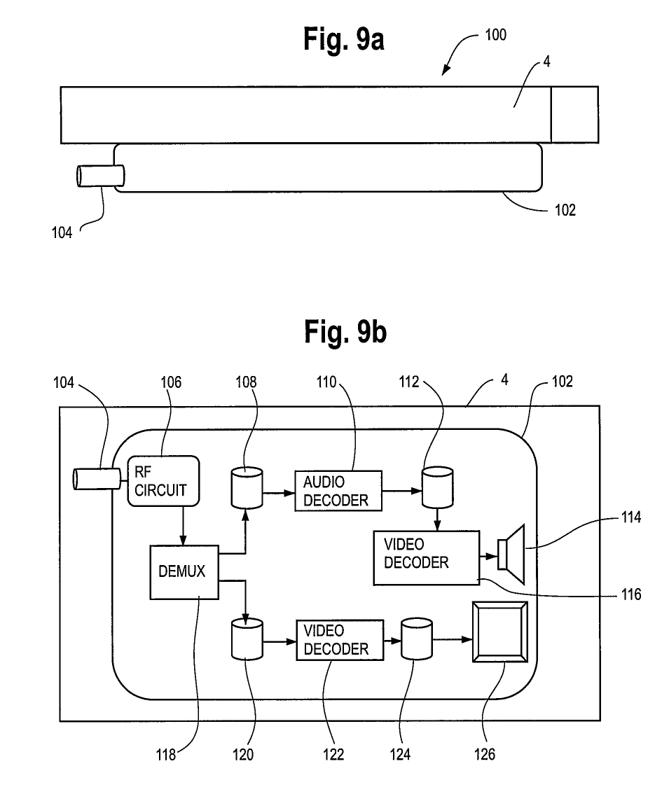

Additionally, dispensing of deodorizers or fragrances, such as perfume, can be controlled with a powered dispensing module, to provide pleasing customization of use or be integrated with the multimedia playback content modules of FIGS. 8 and 9. A fuel cartridge with active olfactory module is shown in FIGS. 3a and 3b. As shown in FIG. 3a, the smart fragrance-dispensing device 28 according to the present fluid fuel cartridge with an integrated content module can be formed in a compact manner and attached or integrated to fuel cartridge 4. The device shown is a handheld battery-operated device, such as described in U.S. Patent Application Publication No. 2002/0043568, which is hereby incorporated by reference herein in its entirety, but other types of powered vapor release devices can be employed as well. Smart miniature fragrance dispensing device 28 consists of an exterior housing 24 for accommodating the different components constituting the device. A frame is further provided which can contain a power source, such as two batteries 23 for powering the odor device. Of course, the power supply can be some other suitable low-power source, such as a car power supply, solar supply or the like. Housing 24 comprises a containment space for at least one airless fragrance reservoir 22. Preferably, this reservoir 22 has an active or passive delivery system and contains a principle fragrance medium, referenced 29 (see FIG. 3b). Advantageously, built into or otherwise arranged within the containment space of reservoir 22, a compensating reservoir, not shown, can be provided for containing a compensation medium, which gradually fills the part of which has become free of reservoir 22 due to expelling of principle medium 29. Such a reservoir and its complementary compensating reservoir are already known as such, and are described, for example, in U.S. Pat. No. 6,062,430, which is incorporated herewith by reference. In short, the reservoir, in fact, contains a first and a second volume respectively filled with a first medium, in the present case the principle medium, and a second medium, wherein the first and second volumes are operationally variable. Preferably, this reservoir is encapsulated to avoid contamination, evaporation and atmospheric influences (ultraviolet light and the like) of the principle medium and allows to operate the device without adding preservatives, stabilizers and the like to the principle medium, as also explained in the above-mentioned U.S. Pat. No. 6,062,430. Of course, other airless reservoirs such as capillary tubes or aluminum bags can be used.

Reservoir 22 is provided with a liquid spray dispenser 37 (see FIG. 3b) for dispensing principle medium 29 into a flow channel 311 which is arranged, for instance, within the top part of housing 24 to receive the principle medium as a spray of droplets. Preferably, flow channel 311 is a controllable induced mixed media flow channel for mixing principle medium 29 dispensed from reservoir 22 with an ambient medium, such as a gas, contained within the flow channel, as will be explained in more detail further on. The flow channel expels the mixed media through an outlet provided in housing 24 so as to allow the fragrance to enter the environment. Housing 24 further contains electronic circuitry suitably arranged for driving liquid spray dispenser 37 and for controlling flow channel 31, and activation means 26 for activating the electronic circuitry and for expelling the fragrance. Such activation means can be for example a simple push button provided on the top of housing 24. Preferably, airless fragrance reservoir 22 is assembled in a leak-tight manner to spray dispenser 37.

Turning now to FIG. 3b, the above-mentioned electronic circuitry contained within smart fragrance dispensing device 28 further comprises at least one memory or other electronic device 36 carrying and communicating identification information about at least principle medium 29 itself, for instance a fragrance, its dispensing and diffusing characteristics, and about the smart fragrance dispensing device 28 and/or its reservoir 22.

Flow channel 31 can consist of a plastic part as represented in FIG. 3b in which heaters can be provided in the form of flow inducing elements 3a providing controlled flows of the sprayed principle medium 29 for dispersion into the induced flow of the ambient medium as largely monodispersive droplets of a range of approximately from about 1 to 10 μm, but preferably smaller than 10 μm in diameter. Flow inducing elements can be in the form of tungsten rings which are individually and sequentially electrically connected in order to create a controlled “chimney effect”, that is, a directed flow of the ambient medium through the flow channel before, during and after the principle medium 29 is dispensed therein, for carrying the mixed media outwards in an efficient manner. In fact, it is possible to regulate the activation of the tungsten rings by applying different currents to the rings so as to control the intensity of the rings thus creating a temperature gradient due to the fact that different rings will heat more or less quickly. Further, the time of applying the current can also be varied. The controlled combination of temperature gradient and actuation time regulates the passage of the principle medium into the gaseous phase and with that the controlled dispersion of the fragrance as a function of its properties, such as its volatility, its dispersion ratio, its intensity and the like, into the surrounding environment or room. This controlled chimney effect thus allows for a control of the absence or presence of the fragrance. Of course, instead of heating elements, a fan could be used to create such a chimney effect, although a fan-less, thermal convection solution is preferred. Preferably, heating elements also stay on for a given time after the dispensing in order to ensure that the flow carries out remnants of the sprayed fragrance. This is especially important when several fragrances are expelled sequentially so as to avoid mutual contamination.

Liquid spray dispenser 37 is arranged for expelling the principle medium 29 through a non-vibrating membrane substrate having non-vibrating, straight output channels, and which extracts the principle medium directly in a valve-less configuration from airless fragrance reservoir 1a. Preferably, dispenser 37 is constituted by a liquid droplet spray device according to European Patent Publication No. 0923957A. Thus, spray dispenser 37 comprises a housing formed by a top-substrate and a bottom-substrate with a space there between for receiving principle medium 29. Ultrasonic vibrating means are arranged on the bottom substrate for vibrating such and for thus forcing the liquid medium through straight outlet channels and nozzles provided in the non-vibrating top substrate so as to expel a spray of monodispersive droplets, as explained in detail in the above-mentioned European application. Dispenser 37 can further be provided with a protection against fragrance evaporation, and is positioned top or bottom up or another suitable position in space in conjunction with the controllable induced mixed media flow channel 31.

The electronic circuitry within the inventive dispensing device 28 further comprises at least one programmable, miniaturized very low energy ultrasonic driver circuit 35 for driving in a valve-less configuration the smart fragrance dispensing device 28 in conjunction with the ultrasonic spray dispenser 37 and providing sensor-less information on the full/empty state of fragrance dispensing device 28.

Referring back to FIG. 3b, preferably, at least one multi-sensor unit (not shown) is further provided. Each unit can be a separated module that can be operatively linked to smart fragrance-dispensing device 28, and is preferably temperature compensated and can be battery or mains powered. Multi-sensor unit consists of at least one ambient air flow sensor and at least one calibrated ambient medium characteristics sensor or sensor-array, for sensing the ambient air motion and condition as compared to a pre-calibrated reference level and the absence or presence and the increase or decrease of the concentration of the principle medium in the ambient medium, for example, the air of a room. Thus, by detecting a variation in the air condition or motion, it is thus possible to release the fragrance in a controlled manner.

A non-disposable control and communication micro-controller unit 34 is further provided for controlling the smart fragrance dispensing device 28, the multi-sensor unit, the ultrasonic driver circuit, as mentioned above this driver is micro-controlled, and the mixed media flow channel 31. Control and communication unit 34 can be of the wired or wireless type and it controls ultrasonic driver circuit 35 and mixed media flow channel 31 in such a manner that the induced mixed media flow is started in time before the driver circuit is activated and stopped in time after the driver circuit is deactivated and otherwise in function of information read from memory device 36, this information being used to adapt to the individual perception of a user by means of adjusting to a desired level and memorizing that level. Control and communication unit 34 and multi-sensor unit are linked in a wired or wireless manner.

Control and communication unit 34 controls and commands the dispensing from smart fragrance dispensing unit 28 via the programmable, ultrasonic driver circuit(s) 33 and mixed media flow channel 31 in accordance with rule-based instructions and information derived from the dispensing characteristics contained in and read from memory device 36 and further in accordance with information read from multi-sensor unit and calculations performed based on the desired presence or absence of single or multiple principle media or components in the ambient medium (the calculations being performed as simple rule, fuzzy logic rule, neural network or virtual sensor quantification rule processing). The desired concentration level(s) of single or multiple principle media in the ambient medium, their sequence of dispensing, their time of presence or absence in the ambient medium and their rate of diffusion, their availability, their concentration as read by multi-sensor unit are adjustable either directly in control and communication unit 34 or remotely via an interface 36 built-in control and communication unit 34. This remote control can be carried out, for example, by telephone, PC, Net appliance etc or Internet communication line or wireless communication, Bluetooth™, and the like, and according to the applicable communication protocols for such devices, web-appliances etc. In particular, this interface can be connected to the multimedia players in FIGS. 8-9.

Interface 36 is provided with communication means 35 which are suitably arranged on the software and/or hardware level to communicate with audio/video synchronizing, sequencing, time lead or lag with regards to video or audio and depending on the properties of the fragrance, for example, its volatility or dispersion ratio etc., thereby controlling instructions for example on movie projectors. For example, in the MPEG standard, subtitles are triggered using a signal just before the frame requiring the subtitle appears. This trigger signal, or a similar signal, can be used for audio synchronizing and for the control of the time lag or time lead. The time lag/lead can be varied as a function of the properties of the fragrance. Indeed, if a fragrance dispenses quickly into the surrounding air, the release command can be triggered later than if the dispensing ratio is slow. In analogy, communication unit 34 is compatible with the applicable multi-media, hypermedia and AV protocols such that interface 36 can be used for the dispensing of single or multiple fragrances, of their time of presence or absence in the ambient air, information about their availability, their rate of diffusion and their concentration as read by the non-disposable multi-sensor unit(s), which can be controlled, synchronized by or sequenced with information contained in the respective multimedia support and storage system. Thus, the innovation of the present smart fragrance dispensing unit lies principally in the use in multimedia application which results from the miniature and smart concept which allows interfacing with the various multimedia standards mentioned and incorporation into a variety of media from cinema seats to PlayStations™, PCs, Net-appliances and/or point-of-sale terminals. Thus, the fragrance dispenser with the multi-sensor unit constitutes a “system” that allows this flexibility, exchangeability of cartridges and adaptability to environments and liquids to be dispensed.

In a further embodiment, control and communication unit 34 is suitably equipped and compatible with the applicable multimedia, hypermedia, Digital Video Broadcasting (DVB) as well as interactive AV protocols, codes and interpreters according to the relevant JPEG, MPEG and MHEG standards, as expressed in the corresponding ISO/IEC documents or according to other proprietary standards or methods in video processing like USB protocol layers (for example, chapter 8) or QuickTime™ encoding and audio processing (for example, MIDI, or Dolby™ digital, LPCM, MP3, AAC (Advanced Audio Coding) etc) or as used in video games and other proprietary audio, video, AV and computer graphics techniques and devices. This interface 36 is being used for orchestrating the dispensing of single or multiple fragrances, of their time of presence or absence in the ambient air, information about their availability, their rate of diffusion and their concentration as read by the multi-sensor unit(s), which can be controlled, synchronized by or sequenced with moving picture, animation, video or audio content, objects etc as contained in the respective multimedia support and storage systems like DVD's and others and related devices, including broadcasting, set-top-boxes, interactive retrieval, VoD (Video on Demand) and the like, and as can be employed in various public or private electronic media environments. Thus, it is further possible to trigger the dispensing of scents to accompany an AV message content.

Housing 24 of smart fragrance dispensing device 28 preferably consists of at least one non-disposable cartridge 37 into which reservoir 22 is fitted. Multi-sensor unit can be used to detect a certain concentration of a certain, first medium, for example, cigarette smoke, in the second, ambient medium of the environment in which the device is placed and to release a third medium, for example, a fragrance, to cover the effect of the first medium by releasing a calculated amount of the third medium. The principle media contained within reservoir 22 can be a fragrance, insect repellent, air disinfectant, air humidification, (aromatic) essence, food or other flavor replicating liquids and volatiles to be dispensed in order to obtain the desired characteristic of the ambient medium of the room or environment in which the present inventive device is placed for operation.

Portable dispensers that can spray irritants such as mace or pepper spray are useful as safety products, but may not always be remembered or easy to access quickly when needed or desired. Incorporating such a dispenser with a fuel cartridge and mobile device such as a cell-phone means for most users, the dispenser is usually on their person and quickly accessible.

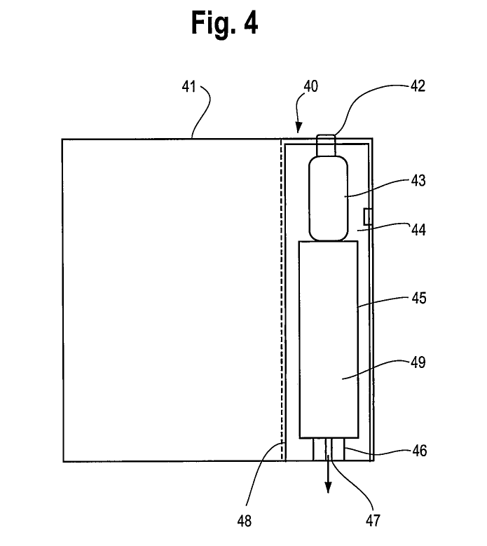

FIG. 4 illustrates an irritant dispenser and cartridge system 40. Fuel cartridge 41 is shown with a secondary cavity shown by the dashed line, and sealed from the stored fuel cavity. Irritant dispenser 48 is housed in the second cavity, and includes pressurized irritant 49 in housing 45 coupled to a valve assembly 46 and spray vent 47. The valve assembly can be spring loaded or in a powered embodiment a powered valve controlled by a circuit. A mechanical actuator 43 coupled to user button 42 can apply force on housing 45 opening spray valve 47 and releasing irritant. Alternate dispenser designs can be accommodated in the cartridge cavity provided they have a similarly accessible actuator for releasing the irritant. The cartridge cavity can be configured for easy replacement of just the irritant housing.

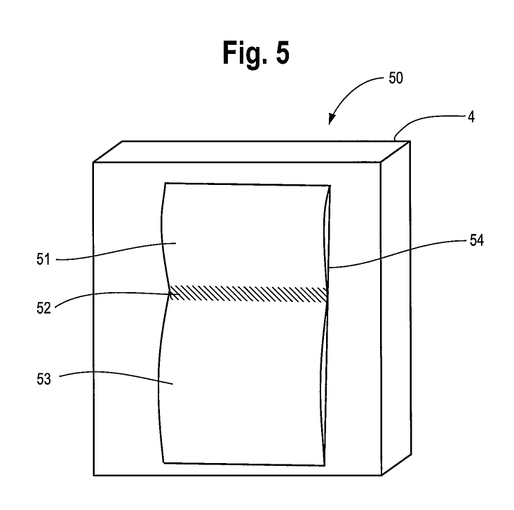

In emergency situations, producing heat is considered an important safety need; however, few people have fully equipped safety kits that are routinely accessible, or have been updated after expiry in the case of chemically activated heat products. In FIG. 5, a heat producing module 54 is shown coupled to a fuel cartridge 4. The heat producing module has two separated chemical materials 51 and 53 with a pressure sensitive divider. When heat is desired, user applies pressure to the pack sufficient to overcome the divider and mix the two chemicals producing an exothermic reaction and excess heat. In an alternate embodiment, a fuel routing and fuel combustor and heat distributor (not shown) can be added to combust the fuel and distribute the heat at safe levels.

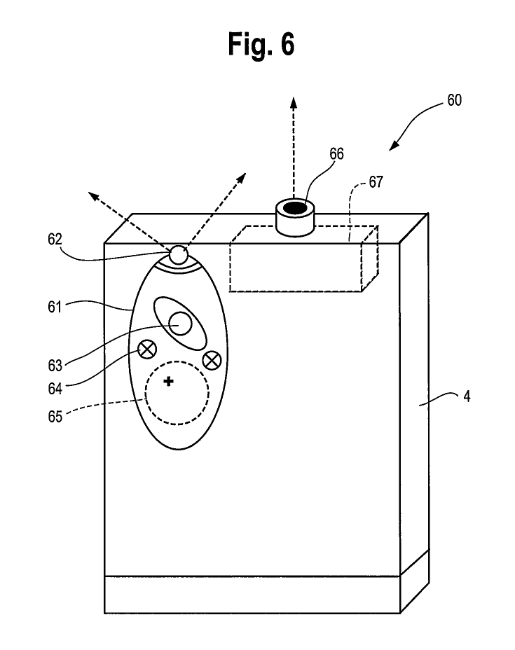

Due to both the low power requirements, small size and reliability, semiconductor light sources are ideal for integration with a fuel cartridge, providing additional functions of illumination, light pointing and IR remote controls such as car door openers, which can now be used in a handheld mobile device context. An embodiment of a content module and fuel cartridge with optical emitters is shown in FIG. 6, specifically for the examples of LED illumination module 61 and laser pointer module 68.

LED illumination module 61 includes a high intensity light-emitting diode (LED) device 62, which includes a lens for focusing light emitted by the LED into a narrow beam directed along the direction of elongation of the flashlight assembly 61 as seen in FIG. 6. On the rear of the flashlight assembly 61 encloses an interior space for receiving a power supply 65, preferably consisting of a pair of coin cells (not shown). A push-button 63, is used to control an electrical switch (not shown) provided inside the LED illumination module 61. The switch can be a simple momentary two-contact switch connected directly to the LED and the power supply so that the LED can be turned on while the button 28 is depressed and is otherwise turned off. Preferably, however, the push-button 28 controls a circuit of the kind described in U.S. Pat. No. 6,249,089, granted on Jun. 19, 2001, to effect more complex operations such as selection from among several illumination levels, selection of one or more flashing modes, and automatic turn-off. The module 61 can be secured to the fuel cartridge 4 by fasteners 64 as shown, with a preferred direction, or alternatively be secured with a rotating latching gimbal for changing emitting axis, or the housing can be releasably secured to the fuel cartridge for use. Preferably, the LED illumination module emits white light.

Laser pointing module 68 can use visible semiconductor lasers and driver circuits, commonly available in products such as laser pens. Upon enabling the laser pointer circuitry (not shown) with power source (not shown) by a switch (not shown), a coherent beam of light exits an aperture 66 in the fuel cartridge 4 and illuminates a small region of a remote surface. A protective housing 67 surrounds the laser pointer circuitry, power source and laser source (not shown) and includes an aperture coupled to aperture 66 through which the substantially coherent beam of visible light is emitted; an optical lens (not shown) can be located within the aperture 66, if necessary or desirable, to focus and concentrate the beam of visible light. Preferably, the laser pointer circuitry (not shown) is selectively coupled to the battery (not shown) by a switch accessible through the fuel cartridge housing. In the embodiment shown, the housing 67 is located inside the fuel cartridge and should be hermetically sealed to withstand the effects of leaked fuel vapor, in particular when formic acid fuel is stored. Alternatively, the housing 67 can be in a separate sealed cavity of the fuel cartridge, or externally mounted to the fuel cartridge similar to the LED illumination module.

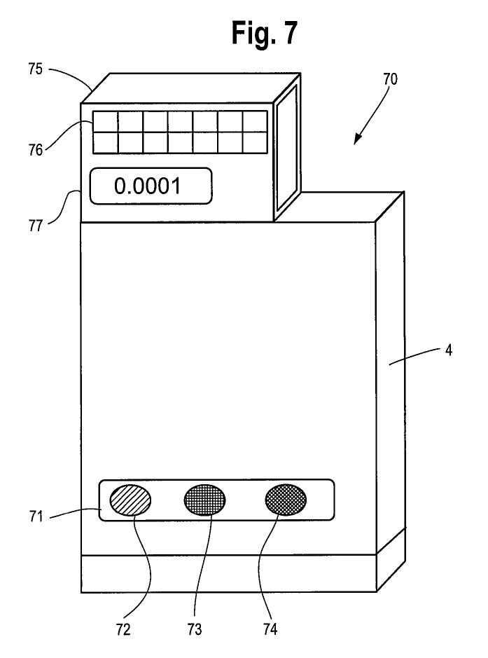

The increasing utilization of wireless devices in many work environments for real-time data and controls includes use in hazardous environments, for example refineries, mines, and nuclear power stations or for monitoring security conditions. Additionally, disposable chemically active materials have been developed that are sensitive to changes in hazardous gas presence. Increased security awareness has also driven miniature handheld radiation sensors. These sensors can be integrated on or in a fuel cartridge associated with a mobile work device utilizing the fuel cartridge, as shown by the sensor module and fuel cartridge 70 in FIG. 7. A visual chemical indicator strip 71 is shown attached to fuel cartridge 4, with three types of chemically sensitive material 72, 73, and 74 which respond with a visual change or color change in the presence of a threshold amount of trace hazardous gas. For example, carbon monoxide or volatile or flammable vapors. In an alternate embodiment, the hazardous sensors could trigger audible alarms with the addition of a photodetector circuit, audio generator circuit and audio transducer (not shown). When the user replaces the fuel cartridge, fresh visual indicator strip 71 is provided, and can be customized to duration of expected time between cartridge replacements.

Radiation detector module 75 includes high-energy semiconductor detector array 76 (such as cadmium zinc Telluride for detecting gamma radiation and X-rays) coupled to detector circuitry (not shown) and power source (not shown) providing signal to a visual display 77 or audio circuit (not shown) for alerts. Alternatively, a radiation sensitive disposable material (not shown) can be used in a similar manner as described for the visual chemical indicator strip 74. Preferably radiation detector module 75 is reusably attachable from fuel cartridge 4 for repeated use, as it is not a disposable commodity.

With the continuing decrease in cost and size of digital storage, multimedia players have been reduced in size suitable for incorporating with a fuel cartridge. For example, Apple Computer Corporation's hand-held audio and video iPod™ players currently include gigabits of hard drive storage in a package thickness down to 0.27 inch (0.69 cm), and in the future the hardware components are anticipated to be very low in value compared to the multimedia content, and hence offered as a product inducement with a fuel cartridge. In the preferred case the storage is provided with the reusable or disposable cartridge and the additional player hardware is releasably attachable for connecting to the stored content for playback—that is, only parts of the hardware may be disposable. An embodiment of a multimedia content module and fuel cartridge 80 is shown in FIGS. 8a and 8b, for storage, playback, recording and manipulation of audio, video and data from the digital storage medium. The storage medium can be another type of digital storage including RAM or hard disk storage shown in the example for illustrative purposes. FIGS. 8a and 8b show a high-level block diagram including the portable player 81 according to one embodiment of the present fluid fuel cartridge with an integrated content module, and a cross-section of the player attached to fuel cartridge 4. As shown in FIGS. 8a and 8b, the portable device 81 comprises two main parts, the portable player 81 and storage 82 in this example a hard drive. The processor 84 prepares the digital data, usually requiring a decompression process, for the D/A converter 91 on the player 81, which in turn converts the digital data from digital format into analog signals. Those signals can then be sent to earphones 88, or alternatively, connected directly to other stand-alone audio amplifiers and external speakers. In the case of a camera or video, the processor 84 would be preparing the digital image for the digital to optical converter, which would finally be projected on a display.

In addition, an A/D converter 86 can convert the audio signal from a microphone 89 or other audio or imaging input and transfers the digitized signal to the processor 84. The digital data is preferably compressed in the processor 84 to reduce the memory requirements of the data. The digital data is stored on an onboard memory 85, preferably non-volatile memory, such as a FLASH-type memory.

Preferably, control buttons 90 on the multimedia module with fuel cartridge 80 allow for operation of the player 81 and its interface with the hard disk 82 via an interface (not shown), which can be a physical hard connector or a wireless interface. The multimedia module with fuel cartridge 80 can also have an interface to allow data-file download/upload from an external communications device, such as a PC, to the portable device hard disk 82. Interface can be a physical hard connector or a wireless interface. The portable device can also include an interface to, for example, a media card 87, which can be available as an additional or alternative on-board memory unit.

The hard disk 82 is preferably a PC style hard disk, such as an ATA-type hard drive. The dimensions and weight of such a hard drive 3 would be suitable for portable applications. The preferred dimensions would be approximately 110 mm by 70 mm by 10 mm, and its weight approximately less than 100 grams. These preferred dimensions currently represent the smallest hard disk available that has achieved the desired low cost per megabyte is this size. As new smaller drives having comparable, or smaller, size and cost become available they can be used with the present fluid fuel cartridge with an integrated content module. Furthermore, like a conventional hard drive, the hard drive 82 is preferably capable of uploading and downloading data very rapidly (for example, about 12 seconds for 32 megabytes of data), the limitation being the speed of the on-board memory. As a result it is possible to rapidly download hours or more of data, such as audio, to the player for playback. After the data has been downloaded, the hard disk can be detached and removed during playtime. Button inputs 90 can include controls for operating a videogame stored in memory 82. The multimedia player is independently operable from the host device the fuel cartridge is connectable to.

An alternate embodiment of the independent multimedia player with fuel cartridge is a wireless broadcast receiver module with fuel cartridge 100 shown in FIGS. 9a and 9b. The increasing popularity of wireless multimedia content has decreased the size and cost of receivers. For example a digital radio satellite company XM, Inc, offers the Roady XT receiver (see www.xm.com) with approximate dimensions of 2 inches by 4 inches by 0.7 inch and weight of 2.6 ounces (73.7 grams), reaching suitability for incorporation with a fuel cartridge. This figure illustrates a schematic and side view of a wireless multimedia player 102 for decoding and playing audio and video, coupled to a fuel cartridge 4.

A schematic illustration of a broadcast receiver system and decoding process in accordance with the present fluid fuel cartridge with an integrated content module is further illustrated with reference to FIGS. 9a and 9b. As shown, antenna 104 and RF circuit 106 receive and condition a broadcast signal, as commonly understood in available broadcast receivers. A received information signal is input to a de-multiplexer 118 that, in turn, provides received encoded audio information and received encoded video information to respective input buffers 108, 118. Thereafter, an audio decoder 110 operates upon the encoded audio information stored in its input buffer 108. The resulting decoded audio information is thereafter provided to a buffer 112. The buffer 112 ensures that the decoded audio information output by the audio decoder 110 will be stored in such a manner that previously output decoded audio information will not be overwritten. Audio circuit 116 includes a D/A converter to cause individual samples of the decoded audio information to be rendered audible via a suitable speaker system 114 (for example, at least one speaker).

Operating in parallel or independently with the audio decoder 110, a video decoder 122 can operate in a slaved fashion relative to the audio decoder 110. In a presently preferred embodiment described below, the indicator can comprise an audio time stamp. The video decoder 122 uses the indicator 430 to determine whether to begin decoding the encoded video information stored in its corresponding input buffer 120 such that the resulting decoded video information will be synchronized to the decoded audio information. The decoded video information provided in this manner is stored to a frame buffer 124, as known in the art. The decoded video information stored in the frame buffer 124 is thereafter rendered on a suitable display device 126 in accordance with well known techniques.

Although the audio decoder 110 and video decoder 122 are preferably implemented using stored software segments executed by a DSP, as described above, it is understood that either or both of the audio decoder 110 and video decoder 122 can be implemented using dedicated circuitry. For example, the video decoder 122 could be implemented using a suitably programmed video co-processor or the like.

Alternate embodiments of the broadcast receiver/player module 102 can include decoders and playback hardware for one of audio or video, and can optionally include memory for storing received content for time-delayed playback.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A removable fluid fuel cartridge having an integrated content module comprising:
(a) a cartridge housing fluidly connectable to the fuel inlet of at least one electrochemical fuel cell providing electric power to a mobile electrical device;
(b) a fuel reservoir disposed within said cartridge housing for containing a quantity of fuel capable of being directed in a fluid stream to at least one fuel cell for accommodating an electrochemical reaction capable of supplying electrical power to said device;
(c) a content module incorporated in said cartridge, said content module independently capable of producing a perceivable stimulus.

2. The fuel cartridge of claim 1 wherein said cartridge contains uploadable data for updating at least one feature of said mobile electrical device.

3. The fuel cartridge of claim 1 wherein said fuel is a liquid at room temperature and pressure.

4. The fuel cartridge of claim 3 wherein said fuel is formic acid.

5. The fuel cartridge of claim 3 wherein said fuel is methanol.

6. The fuel cartridge of claim 1 wherein said fuel is a gas at room temperature and pressure.

7. The fuel cartridge of claim 6 wherein said fuel comprises hydrogen.

8. The fuel cartridge of claim 6 wherein said fuel comprises methane.

9. The fuel cartridge of claim 1, wherein said at least one fuel cell comprises an inlet for receiving said fuel stream and an outlet for discharging an exhaust fuel stream, said cartridge further comprising a trap for accumulating at least one constituent of said exhaust fuel stream.

10. The fuel cartridge of claim 1 wherein said stimulus is a visually perceivable broadcast television image derived from electronic signals generated by a broadcast television receiver and associated television signal processing software incorporated within said content module.

11. The fuel cartridge of claim 1 wherein said stimulus is a visually perceivable videogame image derived from electronic signals generated by videogame processing software incorporated within said content module.

12. The fuel cartridge of claim 1 wherein said stimulus is a visually perceivable prerecorded video image derived from electronic signals generated by prerecorded video image processing software incorporated within said content module.

13. The fuel cartridge of claim 1 wherein said stimulus is a visually perceivable print image derived from electronic signals generated by print image processing software incorporated within said content module.

14. The fuel cartridge of claim 1 wherein said stimulus is a visually perceivable webpage image derived from electronic signals generated by a wireless Internet signal receiver and associated Internet signal processing software incorporated within said content module.

15. The fuel cartridge of claim 1 wherein said stimulus is a visually perceivable image derived from electronic signals generated by a global positioning satellite signal receiver and associated signal processing software incorporated within said content module.

16. The fuel cartridge of claim 1 wherein said stimulus is an aurally perceivable sound derived from electronic signals generated by a broadcast radio receiver and associated audio signal processing software incorporated within said content module.

17. The fuel cartridge of claim 1 wherein said stimulus is an aurally perceivable sound derived from electronic signals generated by a microphone and associated audio signal processing software incorporated within said content module.

18. The fuel cartridge of claim 1 wherein said stimulus is an emitted audible sound stream derived from electronic signals generated by at least one prerecorded soundtrack and associated audio signal processing software and playback circuitry incorporated within said content module.

19. The fuel cartridge of claim 18 wherein said at least one prerecorded soundtrack comprises a plurality of stored prerecorded soundtracks.

20. The fuel cartridge of claim 1 wherein said stimulus is an aurally perceivable tune derived from electronic signals generated by a prerecorded soundtrack and associated audio signal processing software incorporated within said content module said stimulus is an aurally perceivable ringtone derived from electronic signals generated by a prerecorded soundtrack and associated audio signal processing software incorporated within said content module.

21. The fuel cartridge of claim 1 wherein said stimulus is an olfactively perceivable substance derived from an odor-producing substance reservoir and delivery mechanism incorporated within said content module.

22. The fuel cartridge of claim 21 wherein said olfactively perceivable odor is a deodorizer.

23. The fuel cartridge of claim 21 wherein said olfactively perceivable odor is a cosmetic fragrance.

24. The fuel cartridge of claim 1 wherein said stimulus is a semiconductor light-emitting device.

25. The fuel cartridge of claim 24 wherein said semiconductor light-emitting device is a laser pointer.

26. The fuel cartridge of claim 24 wherein said semiconductor light-emitting device comprises a light-emitting diode.

27. The fuel cartridge of claim 1 wherein said stimulus is an actuatable siren.

28. The fuel cartridge of claim 1 wherein said stimulus is a dispensed quantity of an irritant.

29. The fuel cartridge of claim 28 wherein said irritant is pepper spray.

30. The fuel cartridge of claim 28 wherein said irritant is mace.

31. The fuel cartridge of claim 1 wherein said stimulus is a flame-producing cigarette lighter.

32. The fuel cartridge of claim 1 wherein said stimulus is a heat-producing device capable of warming body parts.

33. The fuel cartridge of claim 32 wherein said stimulus is a resistive heat-producing device.

34. The fuel cartridge of claim 32 wherein said stimulus is a chemically exothermic heat-producing device.

35. The fuel cartridge of claim 34 wherein said chemically exothermic heat-producing device comprises a combustion mechanism to which said fuel is directed.

36. The fuel cartridge of claim 1 wherein said mobile electrical device is a cellular telephone.

37. The fuel cartridge of claim 1 wherein said content module comprises a hazardous substance sensor and said stimulus is one of a visually-perceivable, aurally-perceivable and tactilely perceivable indicator actuated in the presence of said substance.

38. The fuel cartridge of claim 37 wherein said substance is said fuel.

39. The fuel cartridge of claim 37 wherein said substance is carbon monoxide.

40. The fuel cartridge of claim 1 wherein said content module comprises fuel cell diagnostic circuitry for assessing at least one performance parameter associated with said electrochemical fuel cell and said stimulus is one of a visually-perceivable, aurally-perceivable and tactilely perceivable indicator of said at least one performance parameter.

41. The fuel cartridge of claim 40 wherein said at least one performance parameter is selected from group consisting of voltage, pressure and presence of contaminants.

42. A mobile electrical device to which electric power is supplied by at least one electrochemical fuel cell, said device comprising a fluid fuel cartridge comprising an integrated content module, said fuel cartridge comprising:
(a) a cartridge housing fluidly connectable to the fuel inlet of said at least one electrochemical fuel cell;
(b) a fuel reservoir disposed within said cartridge housing for containing a quantity of fluid fuel capable of undergoing an electrochemical reaction within said at least one fuel cell;
(c) a content module incorporated in said cartridge, said content module independently capable of producing a perceivable stimulus.
